(19) United States
(12) Patent Application Publication
(10) Pub. No.: US 2020/0034321 A1
(43) Pub. Date: Jan. 30, 2020

(54) HOST DEVICE AND REMOVABLE SYSTEM

(71) Applicant: Panasonic Intellectual Property Management Co., Ltd., Osaka (JP)

(72) Inventor: Tadashi ONO, Osaka (JP)

(21) Appl. No.: 16/592,663

(22) Filed: Oct. 3, 2019

Related U.S. Application Data
(63) Continuation of application No. PCT/JP2018/014482, filed on Apr. 4, 2018.

(30) Foreign Application Priority Data
Apr. 7, 2017 (JP) 2017-076840

(51) Int. Cl. G06F 13/362; G06F 13/38; G06F 13/42; G06F 9/4401; G06F 9/30

(52) U.S. Cl. CPC G06F 13/362; G06F 13/385; G06F 9/30141; G06F 9/4405; G06F 13/426

(57) ABSTRACT

A host device is connected to either a first slave device supporting a first interface or a second slave device supporting a second interface that is different from the first interface. The host device includes an I/F controller that initializes the first interface to a first device connected to the host device, and determines whether or not the first device is the second slave device when the first interface is successfully initialized, and a host-device I/F unit that initializes the second interface if the first device is the second slave device, and continues the initialization of the first interface if the first device is not the second slave device.

### CROSS REFERENCE TO RELATED APPLICATIONS

This application is a U.S. Continuation Application of PCT International Patent Application No. PCT/JP2018/014482 filed on Apr. 4, 2018, claiming the benefit of priority of Japanese Patent Application No. 2017-076840 filed on Apr. 7, 2017, the entire contents of which are hereby incorporated by reference.

### TECHNICAL FIELD

The present disclosure relates to a host device and a removable system.

### BACKGROUND ART

A slave device having market penetration in recent years is equipped with a nonvolatile mass storage element such as a flash memory and is capable of high-speed data processing. Examples of such a slave device include a card-shaped secure digital (SD) card and a memory stick. Such a slave device is used with a host device that is capable of using slave devices, such as a personal computer, a smartphone, a digital camera, an audio player, and a car navigation system.

Disclosed in PTL 1, for example, is a technique of selecting an operating voltage from a plurality of interface voltages in a communication system using a host device and a slave device.

PTL 2 discloses a technique of determining an interface circuit to be used for an electronic device (slave device) according to whether power is ON or OFF and whether a specific signal line is at a high or low level.

A technique disclosed in PTL 3 is such that in cases where a slave device that outputs high-voltage signals is fitted to a host device that supports only low-voltage signals, the slave device is prevented from outputting a high-voltage signal by negotiation between these two devices.

### CITATION LIST

### Patent Literatures

PTL 1: PCT International Publication No. 2009/107400

PTL 2: Unexamined Japanese Patent Publication No. 2003-337639

PTL 3: PCT International Publication No. 2016/132733

### SUMMARY

Nowadays, it is not a unique interface but a general interface that is increasingly introduced to a communication system using a host device and a slave device for the purpose of achieving a reduced number of man-hours for development and maintainability of a verification environment.

For SD cards, there is a 3.3 V single-ended interface (hereinafter described as “legacy I/F”). In order for the SD cards to achieve higher speed and to be usable with a wide range of host devices, Peripheral Component Interconnect Express (PCIe) which is a general interface is desirably introduced to the SD cards.

Also, a slave device equipped with a subscriber identity module (SIM) (SIM integrated SD card) is present as a slave device usable with a host device mounted to a wireless communication device such as a personal computer or a smartphone.

Since the SD cards already have market penetrations, compatibility of interfaces is desirably maintained to enable continued use of the existing SD interface. In other words, in order to be connected to various slave devices including the slave device supporting the legacy I/F (hereinafter described as “legacy slave device”), the slave device supporting the PCIe (hereinafter described as “PCIe slave device”), and the slave device equipped with the SIM, a host device is desired to have, for example, a conformable slot shape, a conformable slot size, and conformable contact positions.

However, what is required of the host device here is control that effects proper initialization of an interface which is supported by the slave device connected to the host device. If, for example, the host device that is fitted with the slave device equipped with the SIM initializes another interface in an initialization routine not supported by that slave device, a contact mismatch (short circuit) is caused between the host device and the SIM and thus can damage the host device or the slave device.

An aspect of the present disclosure has been made in view of the above problem, and a host device and a removable system that are provided according to this aspect maintain compatibility of interfaces and enable safe use.

The host device according to one aspect of the present disclosure is connectable to either a first slave device supporting a first interface or a second slave device supporting a second interface that is different from the first interface. The host device includes a controller and an interface unit. The controller initializes the first interface to a first device connected to the host device. The controller also determines whether or not the first device is the second slave device when the first interface is successfully initialized. When the first device is the second slave device, the controller initializes the second interface. When the first device is not the second slave device, the controller continues the initialization of the first interface.

The removable system according to one aspect of the present disclosure includes a host device, and one of a first slave device and a second slave device. The host device is connectable to either the first slave device or the second slave device. The first slave device supports a first interface. The second slave device supports a second interface that is different from the first interface. The host device initializes the first interface to a first device connected to the host device. When the first interface is successfully initialized, the host device determines whether or not the first device is the second slave device. When the first device is the second slave device, the host device initializes the second interface. When the first device is not the second slave device, the host device continues the initialization of the first interface.

According to one aspect of the present disclosure, the compatibility of the interfaces can be maintained, and the safe use is enabled.

### BRIEF DESCRIPTION OF DRAWINGS

FIG. 1 is a block diagram illustrating a configuration of a removable system including a legacy host device and a legacy slave device.

FIG. 2 illustrates an example of an initialization routine of the removable system including the legacy host device and the legacy slave device.

FIG. 3A illustrates an example of a pin arrangement on the legacy slave device of microSD-card shape.

FIG. 3B illustrates an example of a pin arrangement on a PCIe slave device of microSD-card shape.

FIG. 4 illustrates an example of microSD pin-to-signal correspondences for a legacy I/F and a PCIe.

FIG. 5 illustrates an example of a slave device equipped with a SIM.

FIG. 6 is a block diagram illustrating a configuration of a removable system including a host device and the PCIe slave device according to an exemplary embodiment.

FIG. 7 is a block diagram illustrating a configuration example of a removable system including the host device and the legacy slave device according to one exemplary embodiment.

FIG. 8 is a flowchart illustrating an example of initialization processing performed by the host device according to the exemplary embodiment.

FIG. 9 illustrates an example of a PCIe initialization routine of the removable system including the host device and the PCIe slave device according to the exemplary embodiment.

FIG. 10 is a block diagram illustrating a PCIe initialization routine of the removable system including the host device and the PCIe slave device according to the exemplary embodiment.

FIG. 11A illustrates an example of a pin arrangement on a PCIe slave device including a PCIe I/F contact group.

FIG. 11B illustrates an example of a pin arrangement on a PCIe slave device equipped with a Sim.

FIG. 12A illustrates an example of a pin arrangement on a legacy slave device having the shape of a full-size SD card.

FIG. 12B illustrates an example of a pin arrangement on a PCIe slave device having the shape of the full-size SD card.

FIG. 13 illustrates an example of full-size SD pin-to-signal correspondences for the legacy I/F and the PCIe.

### DESCRIPTION OF EMBODIMENT

An exemplary embodiment is hereinafter described in detail with reference to the drawings as appropriate. However, unnecessarily detailed descriptions may be omitted. For example, detailed descriptions of already well-known matters or repeated descriptions of substantially the same configuration may be omitted. This is to avoid unnecessary redundancy in the following description and to facilitate understanding by those skilled in the art. It is to be noted that those constituent elements having the same reference character in the exemplary embodiment have the same function.

The appended drawings and the following description are provided to allow those skilled in the art to understand the present disclosure and are not intended to limit the subject matter described in the claims.

### [1. Problem to be Solved by Removable System According to Present Disclosure]

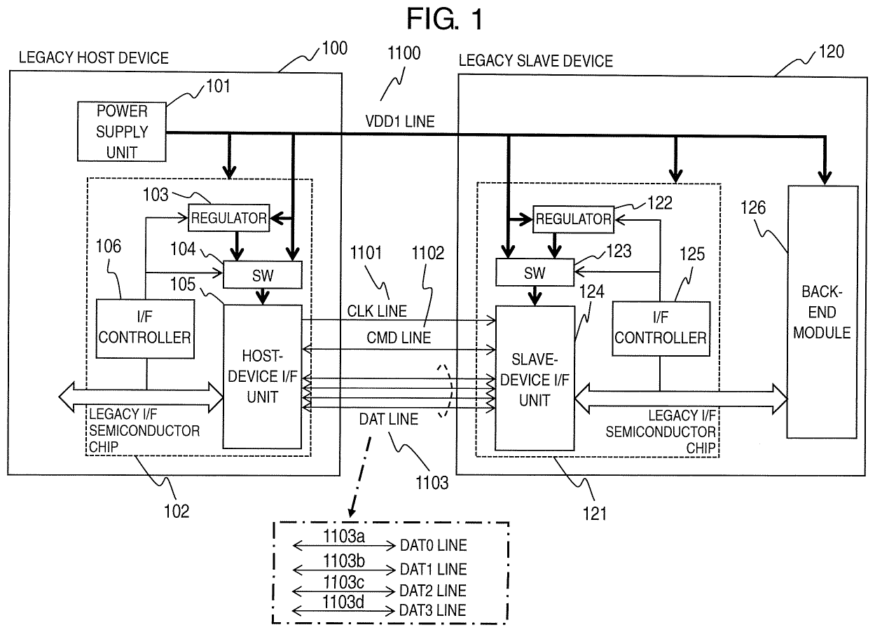

With reference to FIGS. 1 to 5, a description is provided first of a problem to be solved by removable systems according to the present disclosure. It is to be noted that an interface is hereinafter abbreviated to “I/F” as appropriate.

### [1-1. Configuration of Legacy Host Device and Configuration of Legacy Slave Device]

FIG. 1 is a block diagram illustrating a configuration example of a removable system in which legacy slave device 120 is removably connected to legacy host device 100 that supports the legacy I/F.

As illustrated in FIG. 1, legacy host device 100 includes at least power supply unit 101 and legacy I/F semiconductor chip 102. Legacy I/F semiconductor chip 102 includes at least regulator 103, SW 104 which is an electrical switch that selects one of two power inputs, host-device I/F unit 105, and I/F controller 106. It is to be noted that regulator 103 can be disposed outside legacy I/F semiconductor chip 102.

Legacy host device 100 is mechanically connected to legacy slave device 120. Also, legacy host device 100 is electrically connected to legacy slave device 120 via VDD1 line 1100 that is a 3.3 V power supply line as well as via signal lines (described later).

Legacy slave device 120 includes at least legacy I/F semiconductor chip 121 and back-end module 126. Back-end module 126 refers to a recording medium such as a flash memory, or a device such as a wireless communication module. Legacy I/F semiconductor chip 121 includes at least regulator 122, SW 123, slave-device I/F unit 124, and I/F controller 125. It is to be noted that regulator 122 can be disposed outside legacy I/F semiconductor chip 121.

Host-device I/F unit 105 and slave-device I/F unit 124 communicate signals to each other via CLK line 1101, CMD line 1102, and DAT line 1103. DAT line 1103 includes four signal lines, which are DAT0 line 1103a, DAT1 line 1103b, DAT2 line 1103c, and DAT3 line 1103d.

### [1-2. Detailed Operation of Legacy Host Device and Detailed Operation of Legacy Slave Device]

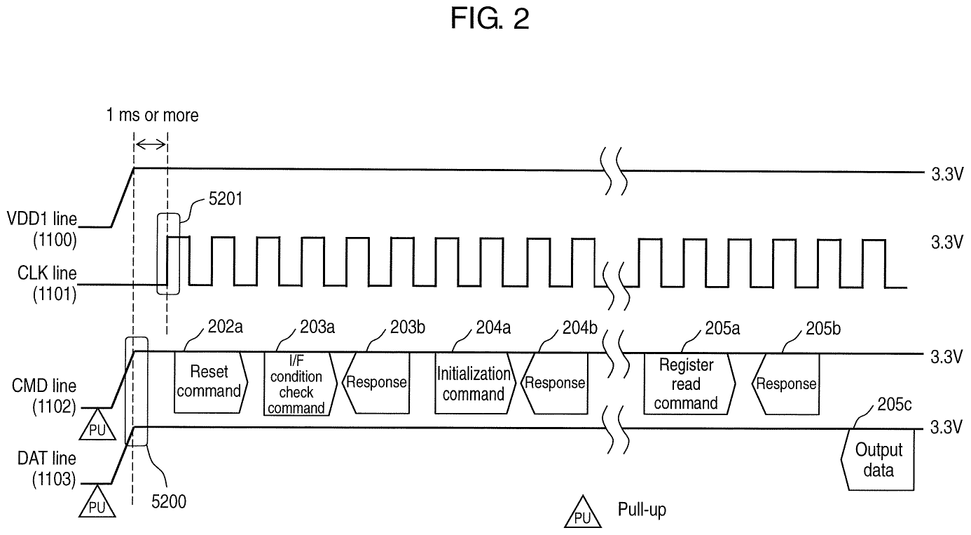

With reference of FIGS. 1 and 2, a description is hereinafter provided of operations that are caused when legacy slave device 120 is connected to legacy host device 100.

FIG. 2 illustrates an initialization routine that operates after power activation of legacy host device 100 and legacy slave device 120 that are illustrated in FIG. 1.

With the power activation, 3.3 V power is supplied from power supply unit 101 of legacy host device 100 to legacy I/F semiconductor chip 102, regulator 103, and SW 104 as well as to legacy slave device 120 via VDD1 line 1100.

Legacy I/F semiconductor chip 102 supplies the 3.3 V power being supplied from power supply unit 101 to all modules disposed inside legacy I/F semiconductor chip 102 to render the modules operable.

Regulator 103 appropriately changes, for output, a voltage of the supplied power according to an instruction from I/F controller 106. In FIGS. 1 and 2, regulator 103 converts the 3.3 V power being supplied from power supply unit 101 to 1.8 V power.

SW 104 selects either the 3.3 V power being supplied from power supply unit 101 or the 1.8 V power being supplied from regulator 103 for supply to host-device I/F unit 105. In FIGS. 1 and 2, SW 104 supplies the 3.3 V power to host-device I/F unit 105 immediately after the power activation. As such, signals that are output from host-device I/F unit 105 via CLK line 1101, CMD line 1102, and DAT line 1103 each have a voltage of 3.3 V.

Meanwhile, the 3.3 V power being supplied to legacy slave device 120 via VDD1 line 1100 is supplied to legacy I/F semiconductor chip 121, regulator 122, SW 123, and back-end module 126.

Legacy I/F semiconductor chip 121 supplies the supplied 3.3 V power to all modules disposed inside legacy I/F semiconductor chip 121 to render the modules operable. In FIGS. 1 and 2, regulator 122 converts the 3.3 V power being supplied via VDD1 line 1100 to 1.8 V power as with regulator 103 of legacy host device 100. SW 123 supplies the 3.3 V power to slave-device I/F unit 124 immediately after the power activation.

With the 3.3 V power supplied to slave-device I/F unit 124, signals that are output from slave-device I/F unit 124 via CMD line 1102 and DAT line 1103 each have a voltage of 3.3 V.

Host-device I/F unit 105 of legacy host device 100 is connected to slave-device I/F unit 124 of legacy slave device 120 by CLK line 1101, CMD line 1102, and DAT line 1103 including the four lines.

A single-ended clock signal is transmitted from legacy host device 100 to legacy slave device 120 via CLK line 1101.

Via CMD line 1102, commands that legacy host device 100 intends to control legacy slave device 120 and responses to the respective commands are transmitted as single-ended signals each having a voltage as high as 3.3 V (hereinafter referred to as 3.3 V signals). For example, the command is transmitted from legacy host device 100 to legacy slave device 120, and the response is transmitted from legacy slave device 120 to legacy host device 100. This means that CMD line 1102 provides two-way communication.

DAT line 1103 including the four signal lines is used mainly for high speed transmission of data contents such as still images, moving images, or texts. DAT line 1103 is configured similarly to CMD line 1102.

When not fitted with legacy slave device 120, legacy host device 100 pulls up each of the lines including CMD line 1102 and DAT line 1103 to a predetermined voltage (normally to 3.3 V) by means of a pull-up resistor (not illustrated) to avoid a floating state of each of the signal lines. Immediately after the power activation, legacy host device 100 uses the pull-up resistor (not illustrated) to connect DAT3 line 1103d and VDD1 line 1100 to legacy slave device 120. This operation is used for detecting whether or not legacy host device 100 is being connected to legacy slave device 120 immediately after the activation.

When the power activation is carried out, each of contacts for CMD line 1102 and DAT line 1103 is neither driven by legacy host device 100 to a low nor high level but is put in an input state, namely, a high-impedance (Hi-Z or open) state. As such, unless these signal lines are driven by legacy host device 100, these signal lines are each transitioned to the high level by the above-mentioned pull-up resistor in association with the VDD1 application (5200).

In this specification, a signal being at the low level means that the signal has a voltage that is around 0 V and normally refers to 0. On the other hand, a signal being at the high level means that the signal has a higher voltage than the low level, can easily be distinguished from the low-level signal and normally refers to 1. It is also to be noted that at the high level, an absolute voltage value differs between a 3.3 V signal and a signal having a voltage as low as 1.8 V (hereinafter referred to as 1.8 V signal).

After the power activation, being supplied with the 3.3 V (high-voltage) power from power supply unit 101 via SW 104, host-device I/F unit 105 generates the single-ended clock in the form of a 3.3 V signal. After a lapse of 1 ms or more following stabilization of the power output from power supply unit 101 at 3.3 V, host-device I/F unit 105 supplies the clock to slave-device I/F unit 124 (5201).

Thereafter, legacy host device 100 enters the initialization routine for characterization of legacy slave device 120 being connected and initialization. Host-device I/F unit 105 issues reset command 202a first. It is to be noted that there is no response to the reset command.

Subsequently, by means of I/F controller 106, legacy host device 100 generates, for transmission to slave-device I/F unit 124 via CMD line 1102, I/F condition check command 203a for checking an I/F condition (e.g., a power supply voltage that is supported) of the connected slave device. I/F condition check command 203a is output to I/F controller 125 via slave-device I/F unit 124. I/F controller 125 interprets contents of I/F condition check command 203a, generates response 203b to I/F condition check command 203a and transmits this reply to legacy host device 100 via CMD line 112.

Subsequently, legacy host device 100 transmits initialization command 204a to legacy slave device 120 via CMD line 1102. As in the case of I/F condition check command 203a, contents of initialization command 204a are interpreted by legacy slave device 120, and response 204b to initialization command 204a is generated and transmitted as a reply to legacy host device 100 via CMD line 1102.

After undergoing thereafter a predetermined initialization process (not described in detail), legacy host device 100 issues register Read command 205a. After receiving response 205b from legacy slave device 120, legacy host device 100 receives output data 205c from legacy slave device 120 via DAT line 1103.

### [1-3. Pin Arrangement on Slave Device]

As mentioned above, introducing the PCIe that is the general interface used in various devices including a personal computer and a smartphone to an SD card (slave device) enables the SD card to be used in a wide range of host devices.

However, what is demanded is maintained compatibility of interfaces to enable continued use of the above-mentioned legacy I/F because the SD card already has market penetration. As such, even if the PCIe is introduced, a host device needs to have a slot shape, a slot size, contact positions, and others that are conformable to the legacy I/F and the PCIe I/F.

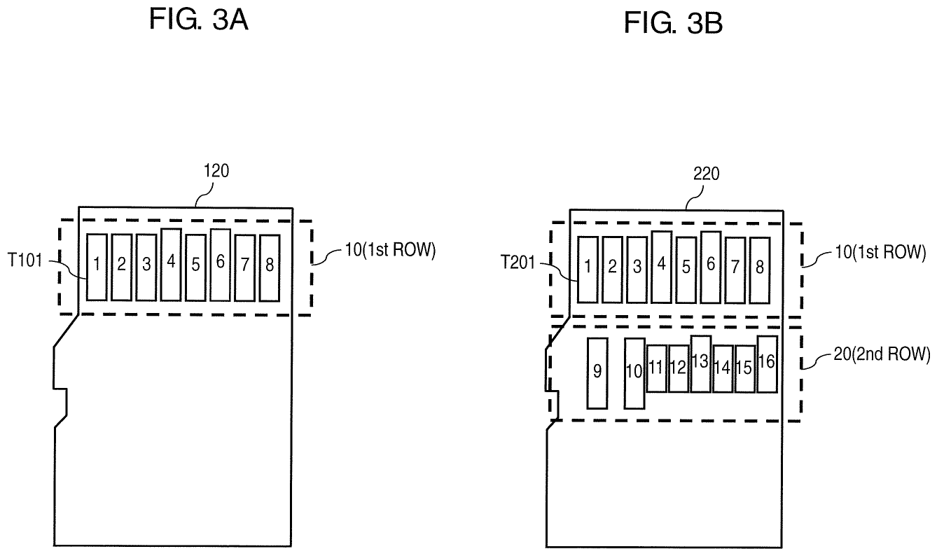

FIG. 3A illustrates an example of an arrangement of contacts (pins) on legacy slave device (microSD card) 120 that supports only the legacy I/F. FIG. 3B illustrates an example of an arrangement of contacts (pins) on PCIe slave device (microSD card) 220 that supports the PCIe which is described later.

Arranged on legacy slave device 120 illustrated in FIG. 3A are eight contacts T101 (pins 1 to 8) that respectively correspond to the lines including the power supply line and the signal lines. In legacy slave device 120 illustrated in FIG. 3A, an area (row) including those eight contacts T101 is described as first area (first row) 10.

On the other hand, arranged on PCIe slave device 220 illustrated in FIG. 3B are sixteen contacts T201 (pins 1 to 16) that respectively correspond to lines including a power supply line and signal lines. In PCIe slave device 220 illustrated in FIG. 3B, those sixteen contacts T201 include pins 1 to 8 that are included in first area (first row) 10 as in FIG. 3A, and pins 9 to 16 that are included in second area (second row) 20 that is different from first area 10. Specifically, the contact group included in first area 10 is based on the pin arrangement for the legacy I/F (refer to FIG. 3A), while the contact group included in second area 20 makes the PCIe or a UHS-II available.

In legacy slave device 120 illustrated in FIG. 3A, that supports only the legacy I/F, the contact group that is used for both the legacy I/F and the PCIe I/F are arranged in first area (first row) 10. On PCIe slave device 220 that supports the PCIe, on the other hand, the contact group that is used for both the legacy I/F and the PCIe I/F are arranged in first area (first row) 10, while the contact group that is used for only the PCIe I/F are arranged in second area (second row) 20 that is different from first area 10.

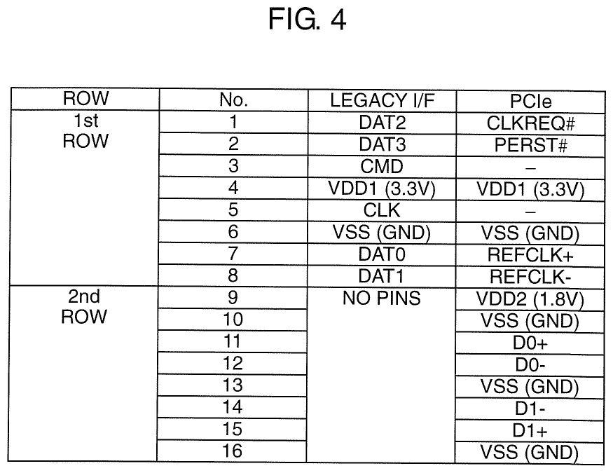

FIG. 4 illustrates microSD-card correspondences between legacy I/F contacts T101 (pins 1 to 8) and the lines including the power supply line and the signal lines as well as between PCIe contacts T201 (pins 1 to 16) and the lines including the power supply line and the signal lines.

As illustrated in FIG. 4, for the legacy I/F, 3.3 V power supply, ground (GND), CLK, CMD, and DAT are assigned to first-row pins 1 to 8. It is to be noted that for the legacy I/F, pins are not arranged in a second row (no pins).

For the PCIe, on the other hand, the power supply line (described later) and the signal lines (described later) are assigned, as illustrated in FIG. 4, to pins 1 to 16 arranged in the first and second rows.

As illustrated in FIG. 4, respective uses of pins 1 to 8 that are arranged in first area (first row) 10 and are common to the legacy I/F and the PCIe vary corresponding to the interface. When using the pins arranged in first area 10 of the slave device being fitted, a host device that supports both the legacy I/F and the PCIe (such a host device is described later) changes the respective uses of those pins according to the interface to use.

It is to be noted that although pin 5 is not assigned any of the lines including the power supply line and the signal lines for the PCIe in FIG. 4, pin 5 may be put to another use. For example, for the PCIe, pin 5 may be set as a signal line for transmitting a signal that gives notice of a start of PCIe I/F initialization.

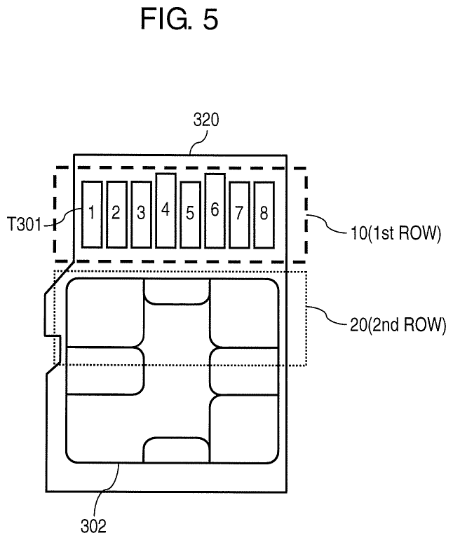

Next, FIG. 5 illustrates an example of an arrangement of contacts (pins) and a SIM on slave device (microSD card) 320 equipped with the SIM.

As illustrated in FIG. 5, arranged on slave device 320 are eight contacts T301 (pins 1 to 8) respectively corresponding to lines including a power supply line and signal lines, and SIM 302. As in legacy slave device 120 and PCIe slave device 220, eight contacts T301 (pins 1 to 8) here are arranged in first area (first row) 10. This means that slave device 320 illustrated in FIG. 5 supports the legacy I/F. SIM 302, on the other hand, is disposed in an area that covers a part of second area 20 outside first area 10 of slave device 320 as illustrated in FIG. 5. With the slot shape, the slot size, the contact positions, and others being conformable to any of the cases including the use of the legacy I/F (FIG. 3A), the introduction of the PCIe (FIG. 3B), and the equipment of the SIM (FIG. 5), the compatibility of the interfaces can be maintained.

However, negotiation is required between a host device and each of the above three types of slave devices as to which I/F to the slave device should be selected. Moreover, when the host device selects the I/F not supported by the slave device and tries to initialize that selected I/F, it is necessary that the initialization does not cause a fatal problem such as breakdown to both the host device and the card device.

In slave device 320 illustrated in FIG. 5, for example, the area in which SIM 302 is disposed partly covers second area (second row) 20 where the contact group are arranged in the case of PCIe slave device 220 illustrated in FIG. 3B to make the PCIe available. As such, when the PCIe I/F is initialized by a host device that supports the PCIe (such a host device is described later) with slave device 320 illustrated in FIG. 5 fitted to the host device, a contact mismatch (short circuit) is caused between the host device and SIM 302 and thus can damage the host device and slave device 320 (SIM 302).

Accordingly, the present disclosure provides a solution to this problem acknowledged in a process of development of a removable system. A concrete and detailed description is hereinafter provided of the solution. The following description is of the exemplary embodiment that is given as an example embodying a technical idea of the solution.

### [2. Configurations and Operations of Removable Systems According to Exemplary Embodiment]

[2-1. Configuration in which PCIe Slave Device is Connected to Host Device]

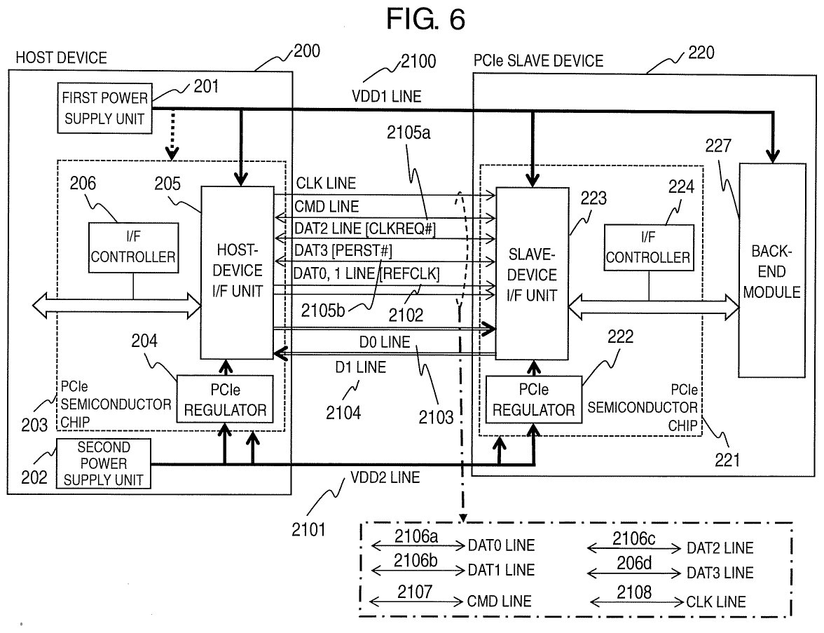

FIG. 6 is a block diagram illustrating a configuration example of a removable system in which PCIe slave device 220 is removably connected to host device 200 according to the present exemplary embodiment.

As illustrated in FIG. 6, host device 200 includes at least first power supply unit 201, second power supply unit 202, and PCIe semiconductor chip 203. PCIe semiconductor chip 203 includes PCIe regulator 204, host-device I/F unit 205, and I/F controller 206. Host device 200 is connected to a slave device at least through the legacy I/F or the PCIe I/F.

It is to be noted that PCIe regulator 204 can be disposed outside PCIe semiconductor chip 203. It is also to be noted that although host device 200 according to the present exemplary embodiment is composed of first power supply unit 201, second power supply unit 202, and PCIe semiconductor chip 203, PCIe semiconductor chip 203 can alone implement host device 200 of the present exemplary embodiment, provided that power can be supplied to PCIe semiconductor chip 203.

Host device 200 is mechanically connected to PCIe slave device 220. Also, host device 200 is electrically connected to PCIe slave device 220 via VDD1 line 2100, VDD2 line 2101, and signal lines (described later). Respective power supply voltages of VDD1 and VDD2 here are 3.3 V and 1.8 V, respectively.

PCIe slave device 220 includes at least PCIe semiconductor chip 221 and back-end module 227. PCIe semiconductor chip 221 includes at least PCIe regulator 222, slave-device I/F unit 223, and I/F controller 224. Slave-device I/F unit 223 includes, for example, the pin arrangement illustrated in FIG. 3B and is connected to host-device I/F unit 205 of host device 200.

It is to be noted that although PCIe slave device 220 according to the present exemplary embodiment is composed of PCIe semiconductor chip 221 and back-end module 227, PCIe semiconductor chip 221 can alone implement PCIe slave device 220 of the present exemplary embodiment.

Host-device I/F unit 205 and slave-device I/F unit 223 communicate signals to each other via REFCLK line 2102, D0 line 2103, D1 line 2104, CLKREQ # line 2105a, and PERST # line 2105b. D0 line 2103 and D1 line 2104 are used for the PCIe I/F. REFCLK line 2102 includes DAT0 line 2106a and DAT1 line 2106b (refer to, for example, FIG. 4). CLKREQ # line 2105a and DAT2 line 2106c are assigned to the common contact and are a common signal line, and PERST # line 2105b and DAT 3 line 2106d are assigned to the common contact and are a common signal line (refer to, for example, FIG. 4).

It is to be noted that each of host device 200 and PCIe slave device 220 also includes those contacts (included in first area 10 illustrated in FIG. 3B) that are used for the legacy I/F so that at least the legacy I/F can be used for communication when legacy slave device 120 is connected to host device 200 or when PCIe slave device 220 is connected to legacy host device 100. It is also to be noted that host device 200 does not have to support the legacy I/F.

CMD3 line 2107 is not used for the PCIe but is being electrically connected to enable, as mentioned above, host device 200 or PCIe slave device 220 to operate using the legacy I/F. Legacy host device 100 and legacy slave device 120 that do not each have a PCIe function, on the other hand, do not each include those contacts for VDD2 line 2101, D0 line 2103, and D1 line 2104 that are used for only the PCIe.

[2-2. Configuration in which Legacy Slave Device is Connected to Host Device]

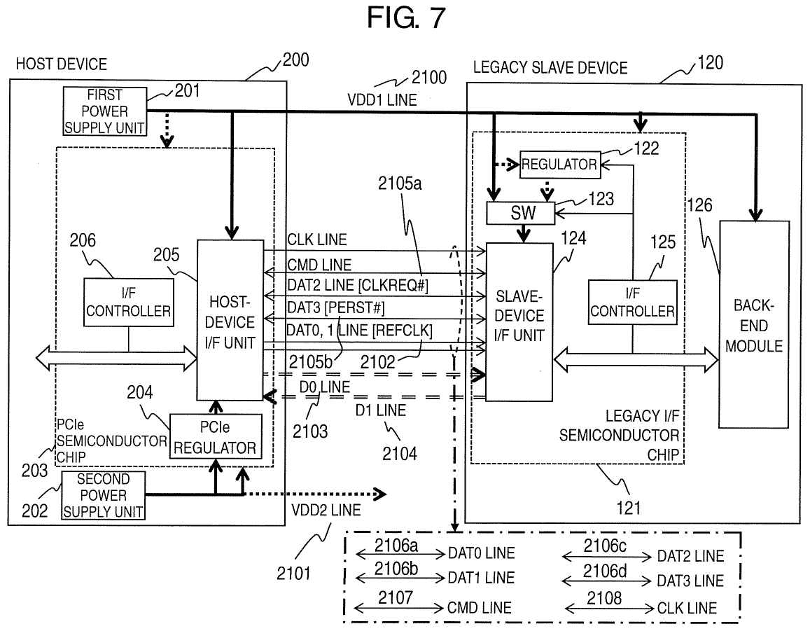

FIG. 7 is a block diagram illustrating a configuration example of a removable system in which legacy slave device 120 is removably connected to host device 200 according to the present exemplary embodiment.

Host device 200 is configured as in the block diagram illustrated in FIG. 6, and legacy slave device 120 is configured as in the block diagram illustrated in FIG. 1.

Slave-device I/F unit 124 of legacy slave device 120 includes, for example, the pin arrangement illustrated in FIG. 3A and is connected to host-device I/F unit 205 of host device 200.

This means that while host device 200 and legacy slave device 120 are mechanically connected to each other, legacy slave device 120 does not have those contacts for VDD2 line 2101, D0 line 2103, and D1 line 2104. As such, host device 200 and legacy slave device 120 are electrically connected to each other via VDD1 line 2100, DAT0 line 2106a, DAT1 line 2106b, DAT2 line 2106c, DAT3 line 2106d, CMD line 2107, and CLK line 2108.

Although FIG. 7 illustrates the configuration of the removable system in which legacy slave device 120 (of FIG. 3A, for example) is removably connected to host device 200, a removable system in which slave device 320 (of FIG. 5, for example) that is equipped with the SIM is removably connected to host device 200 is configured as in FIG. 7.

### [2-3. Detailed Operation]

With reference to FIGS. 2, 6, 7, 8, and 9, a description is hereinafter provided of operation that is caused when legacy slave device 120 (FIG. 3A), PCIe slave device 220 (FIG. 3B), slave device 320 equipped with the SIM (FIG. 5), or a device having neither the legacy I/F nor the PCIe (e.g., a SIM card alone) (not illustrated) is connected to host device 200.

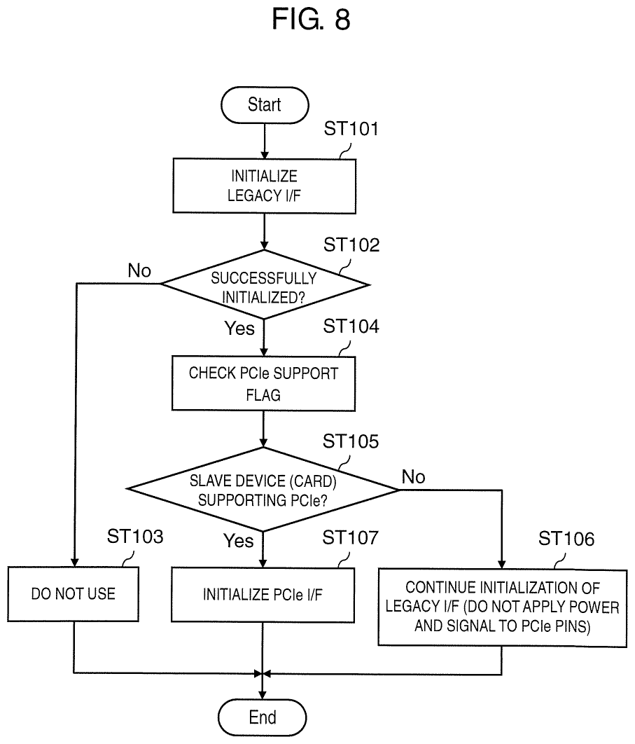

FIG. 8 is a flowchart illustrating the operation that is caused according to the present exemplary embodiment after power activation with any of the above devices being connected to host device 200.

Host device 200 first initializes the legacy I/F to the device connected to host device 200 (ST101). In other words, after the power activation, host device 200 starts operation of the legacy I/F initialization routine described with reference to FIG. 2 regardless of the device connected to host device 200.

Next, host device 200 (I/F controller 206) determines whether or not the legacy I/F is successfully initialized at ST101 (ST102). As described with reference to FIG. 2, the slave device (120, 220, 320) supporting the legacy I/F interprets contents of I/F condition check command 203a which is intended to check the I/F condition of the slave device connected to host device 200 and replies by transmitting response 203b to host device 200 via CMD line 2107. If response 203b is obtained from the device being connected, host device 200 determines that the legacy I/F is successfully initialized (ST102: Yes). If no response 203b is obtained from the device being connected, host device 200 determines that the initialization of the legacy I/F has failed (ST102: No).

In this way, host device 200 can determine whether or not the device being connected supports the legacy I/F. In other words, host device 200 can determine whether the device being connected is the slave device (120, 220, 320) supporting the legacy I/F or the PCIe or the device with neither of the interfaces.

If the initialization of the legacy I/F has failed (ST102: No), host device 200 determines next that the device being connected is not the slave device (e.g., the SD card) and thus cannot be used (ST103). It is to be noted that host device 200 may perform SIM initialization on the connected device (e.g., the SIM card) on this occasion.

If, on the other hand, the legacy I/F is successfully initialized (ST102: Yes), host device 200 checks a PCIe support flag that is indicative of whether or not the slave device being connected supports the PCIe (ST104). Host device 200 may obtain the PCIe support flag from the slave device by, for example, any of methods 1 to 4 below.

### (Method 1)

The PCIe support flag is included in response 203b to I/F condition check command 203a that is included in the legacy I/F initialization routine illustrated in FIG. 2. This means that host device 200 has only to check the PCIe support flag included in that response 203b when ascertaining at ST102 based on response 203b that the legacy I/F is successfully initialized.

### (Method 2)

The PCIe support flag is included in response 204b to initialization command 204a which directs in the legacy I/F initialization routine illustrated in FIG. 2 that the I/F be initialized. This means that after ascertaining at ST102 based on response 203b that the legacy I/F is successfully initialized, host device 200 has only to transmit initialization command 204a to check the PCIe support flag included in response 204b.

### (Method 3)

The PCIe support flag is included in output data 205c that the slave device transmits in response to register Read command 205a that is included in the legacy I/F initialization routine illustrated in FIG. 2. This means that after ascertaining at ST102 based on response 203b that the legacy I/F is successfully initialized, host device 200 has only to carry out the processes until register Read command 205a is transmitted to check the PCIe support flag included in output data 205c.

### (Method 4)

The PCIe support flag is included in a response to another command (special command) (not illustrated) that host device 200 issues in the legacy I/F initialization routine illustrated in FIG. 2 besides the commands respectively described in methods 1 to 3. Host device 200 becomes capable of issuing the special command after, for example, receiving response 204b. This means that after ascertaining at ST102 based on response 203b that the legacy I/F is successfully initialized, host device 200 has only to carry out the processes until the special command is transmitted to check the PCIe support flag included in the response to the special command.

The methods for obtaining the PCIe support flag have been described above.

Next, host device 200 (I/F controller 206) determines, based on the PCIe support flag transmitted at ST104 from the slave device being connected, whether or not the connected slave device supports the PCIe (or is PCIe slave device 220) (ST105).

In each of above-mentioned methods 1 to 4, the PCIe support flag may indicate, for example, “1” if the slave device supports the PCIe, and if the slave device does not support the PCIe, the PCIe support flag may indicate, for example, “0”. It is to be noted that the PCIe support flag is not limited to these values. In each of above-mentioned methods 1 to 4, the PCIe support flag may be included as a reserved bit not currently used in a format of the signal (response or output data) including the PCIe support flag. Since the reserved bit of legacy slave device 120 already shipped is “0”, host device 200 can properly determine based on the PCIe support flag whether or not even already shipped legacy slave device 120 supports the PCIe.

The slave device may indicate whether the slave device supports the PCIe only when the host device inquires whether the slave device supports the PCIe. In above-mentioned (method 1), for example, when inquiring whether the PCIe is supported, a PCIe support query flag indicating “1” is multiplexed with I/F condition check command 203a; otherwise, the PCIe support query flag indicating “0” is multiplexed. Only when I/F condition check command 203a is received with the PCIe support query flag being “1”, the slave device may indicate with “1” that the slave device supports the PCIe and may indicate with “0” that the slave device does not support the PCIe. When I/F condition check command 203a is received with the PCIe support query flag being “0”, the slave device may always indicate “0”.

Next, if the slave device being connected does not support the PCIe, that is, the slave device is legacy slave device 120 (FIG. 3A) or slave device 320 (FIG. 5) (ST105; No), host device 200 continues the initialization of the legacy I/F (ST106). Specifically, host-device I/F unit 205 of host device 200 executes, via the legacy I/F contact group (pins 1 to 8 of FIG. 3A or 5) included in first area 10, a continuation of the legacy I/F initialization processing executed for the ST102 determination as to whether the legacy I/F is initialized and the determination based on the ST104 PCIe support.

This means that host device 200 that continues the initialization of the legacy I/F does not supply (apply) power and signals to second area (second row) 20 where in the case of PCIe slave device 220 (FIG. 3B) that supports the PCIe, the contact group (described as PCIe pins) are arranged to make the PCIe available.

As such, even if slave device 320 equipped with the SIM (FIG. 5), for example, is connected to host device 200, host device 200 can communicate with slave device 320 via the legacy I/F contact group (the power supply line and the signal lines) arranged in first area 10 without supplying power and signals to SIM 302 disposed over second area 20. In this way, a contact mismatch (short circuit) can be prevented between host device 200 and slave device 320 (SIM 302).

If, on the other hand, the slave device being connected supports the PCIe or is PCIe slave device 220 (ST105: Yes), host device 200 initializes the PCIe I/F (ST107). Specifically, host-device I/F unit 205 of host device 200 initializes the PCIe I/F via the PCIe I/F contact groups (pins 1 to 16 of FIG. 3B) included in first and second areas 10 and 20.

(Cases where PCIe Slave Device 220 is Fitted)

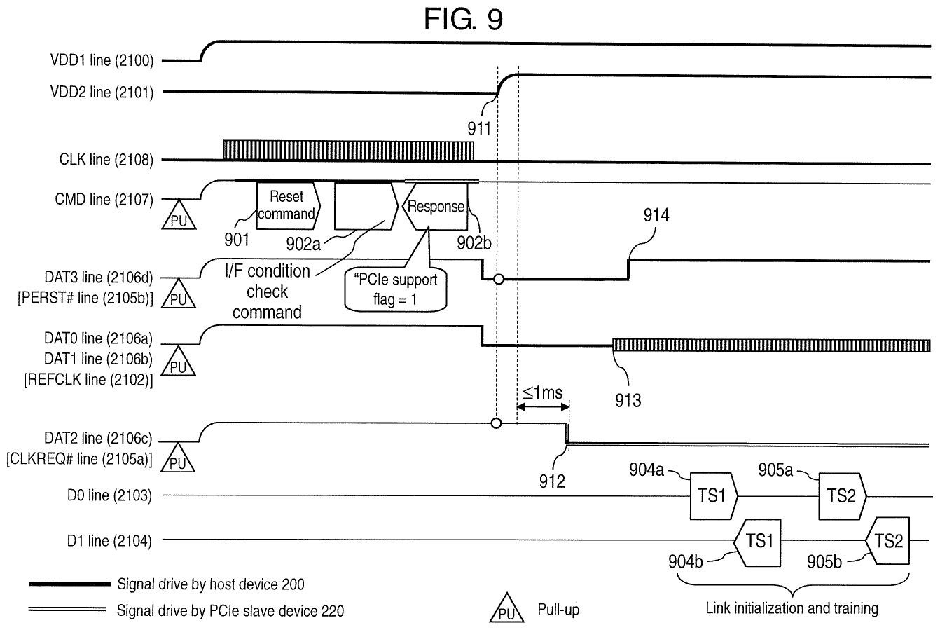

With reference to FIGS. 6 and 9, a description is hereinafter provided of PCIe I/F initialization operation that is caused when PCIe slave device 220 is connected to host device 200. It is to be noted that host device 200 may perform power cycling (a power supply reset) before initializing the PCIe I/F at ST107.

FIG. 9 illustrates the initialization operation in the removable system including host device 200 and PCIe slave device 220 in the present exemplary embodiment.

Before power is supplied, PCIe slave device 220 according to the present exemplary embodiment has DAT0 line 2106a, DAT1 line 2106b, DAT2 line 2106c, DAT3 line 2106d, and CMD line 2107 all in a Hi-Z state.

With power activation, host device 200 supplies 3.3 V power from first power supply unit 201 to host-device I/F unit 205 via VDD1 line 2100.

The 3.3 V power supplied to host-device I/F unit 205 is used for generation of 3.3 V signals that are output from host-device I/F unit 205 via CLKREQ # line 2105a, PERST # line 2105b, and CLK line 2108.

Host device 200 also supplies 1.8 V power from second power supply unit 202 to PCIe semiconductor chip 203 and PCIe regulator 204 via VDD2 line 2101.

PCIe semiconductor chip 203 supplies the supplied 1.8 V power to all modules disposed inside PCIe semiconductor chip 203 to render the modules operable. It is to be noted that instead of being the above-mentioned 1.8 V power, the power supplied to PCIe semiconductor chip 203 may be the 3.3 V power that is supplied via VDD1 line 2100.

PCIe regulator 204 appropriately changes, for output or supply to host-device I/F unit 205, a voltage of the supplied 1.8 V power to a reduced voltage (which ranges from 0.4 V to 1.2 V, inclusive and is 0.4 V below for convenience' sake) that is equivalent to an amplitude of a differential signal which is used in the PCIe I/F. With this reduced-voltage power, 0.4 V differential serial signals are generated and are output from host-device I/F unit 205 via REFCLK line 2102 and D0 line 2103.

Meanwhile, the 3.3 V power is supplied to PCIe slave device 220 via VDD1 line 2100 and is supplied to slave-device I/F unit 223 to be used for generation of 3.3 V signals that are output from slave-device I/F unit 223 via CLKREQ # line 2105a and PERST # line 2105b.

The 1.8 V power is also supplied to PCIe slave device 220 via VDD2 line 2101 and is supplied to PCIe semiconductor chip 221 and PCIe regulator 222. PCIe semiconductor chip 221 supplies the supplied 1.8 V power to all modules disposed inside PCIe semiconductor chip 221 to render the modules operable. The 1.8 V power supplied to PCIe regulator 222 has a voltage reduced to 0.4 V to be supplied to slave-device I/F unit 223. With this 0.4 V power, a 0.4 V differential serial signal is generated and is output from slave-device I/F unit 223 via D1 line 2104. It is to be noted that instead of being the above-mentioned 1.8 V power, the power supplied to PCIe semiconductor chip 221 may be the 3.3 V power that is supplied via VDD1 line 2100.

A differential reference clock using differential serial system is unidirectionally transmitted from host device 200 to PCIe slave device 220 via REFCLK line 2102. Signals (a Transaction Layer Packet, a Data Link Layer Packet, and a special symbol) using the differential serial system are transmitted from host device 200 to PCIe slave device 220 via D0 line 2103 (including two signal lines). Signals using the differential serial system are transmitted from PCIe slave device 220 to host device 200 via D1 line 2104 (including two signal lines).

With reference to FIG. 9, a description is provided next of a PCIe I/F initialization routine that is operated by host device 200 and PCIe slave device 220.

Host device 200 pulls up each of the lines including CMD line 2107 and all DAT lines 2106 to 3.3 V which is the same level as that of VDD1 line 2100 by means of a pull-up resistor (not illustrated) included in host device 200 and puts CMD line 2107 and DAT lines 2106 all in the Hi-Z state. As such, as illustrated in FIG. 9, these signal lines are each transitioned to the high level, following the VDD1 activation.

After supplying a clock via CLK line 2108, host device 200 transmits reset command 901 and I/F condition check command 902a and receives response 902b from PCIe slave device 220 as in FIG. 2.

If the value of the PCIe support flag included in response 903 is “1” meaning that PCIe slave device 220 supports the PCIe, host device 200 drives CMD line 2107, DAT0 line 2106a, DAT1 line 2106b, and DAT3 line 2106d respectively to the low levels and stops supplying the clock via CLK line 2108. Thereafter, DAT0 line 2106a and DAT1 line 2106b are used as REFCLK line (2102), the DAT2 line is used as CLKREQ # line 2105a, and DAT3 line 2106d is used as PERST # line 2105b.

Upon detecting that PERST # line 2105b is at the low level, while CLKREQ # line 2105a is at the high level, host device 200 supplies the 1.8 V power via VDD2 line 2101 (911).

After detecting the 1.8 V power via VDD2 line 2101, PCIe slave device 220 drives CLKREQ # line 2105a to the low level, for example, within 1 ms (912). This operation is intended to notify host device 200 that PCIe slave device 220 is open to initialization of the PCIe I/F. For the PCIe I/F, a low-level signal of CLKREQ # line 2105a is also meant to request supply of a clock from host device 200. Since CLKREQ # line 2105a is not being driven by host device 200 but in the Hi-Z state, there is no problem even if CLKREQ # line 2105a is driven to the low level by PCIe slave device 220.

It is to be noted that the specified time period between the detection of the 1.8 V power and the driving of CLKREQ # line 2105a to the low level that are performed by PCIe slave device 220 is, for example, 1 ms but may be another value. It is also to be noted that a specific value specifying a time period below is an example and may be another value.

Upon detecting that CLKERQ #2105a is at the low level at timing 912, host-device I/F unit 205 notifies I/F controller 206. When notified that CLKERQ # line 2105a is at the low level, I/F controller 206 determines that the slave device being connected supports the PCIe I/F.

As described above, as to whether or not the connected slave device supports the PCIe I/F, host device 200 is capable of two-stage ascertainment that includes the determination based on the PCIe support flag at ST104 and ST105 of FIG. 8 and the determination associated with the PCIe I/F initialization operation. As such, even when, for example, host device 200 mistakenly determines that the PCIe support flag from connected slave device 320 indicates the support for the PCIe, host device 200 can correctly determine that slave device 320 does not support the PCIe I/F based on the determination illustrated in FIG. 9 as to whether the PCIe is supported, so that a contact mismatch (short circuit) can be prevented between host device 200 and slave device 320 (SIM 302).

When I/F controller 206 of host device 200 determines that the slave device being connected supports the PCIe I/F, the differential serial clock signal is supplied to PCIe slave device 220 via REFCLK line 2102 (913), and PERST # line 2105b is thereafter driven to the high level (914). A high-level signal here means that the reset state has been cleared.

Thereafter, host device 200 performs link initialization and training in relation to PCIe slave device 220. Specifically, host device 200 transmits TS1 symbol 904a which is a kind of special symbol to PCIe slave device 220 via D0 line 2103. Then PCIe slave device 220 transmits TS1 symbol 904b to host device 200 via D1 line 2104. With this symbol exchange, more detailed information is set for communication through the PCIe I/F.

Subsequently, host device 200 transmits TS2 symbol 905a to PCIe slave device 220, and PCIe slave device 220, in turn, transmits TS2 symbol 905b to host device 200, thus effecting the information exchange, and the initialization of the PCIe I/F is completed.

The PCIe I/F initialization operation has been described above.

It is to be noted that if PCIe slave device 220 is determined, based on the PCIe support flag, as supporting the PCIe at ST105 in FIG. 8, host device 200 and PCIe slave device 220 do not have to perform the operation (associated with the determination as to whether or not the PCIe is supported) that lasts until timing 912 illustrated in FIG. 9. Host device 200 may determine whether the PCIe is supported or not by performing the operation until timing 912 in FIG. 9 instead of using the PCIe support flag that appears at ST104 in FIG. 8.

(Cases where PCIe Slave Device 220 is not Fitted)

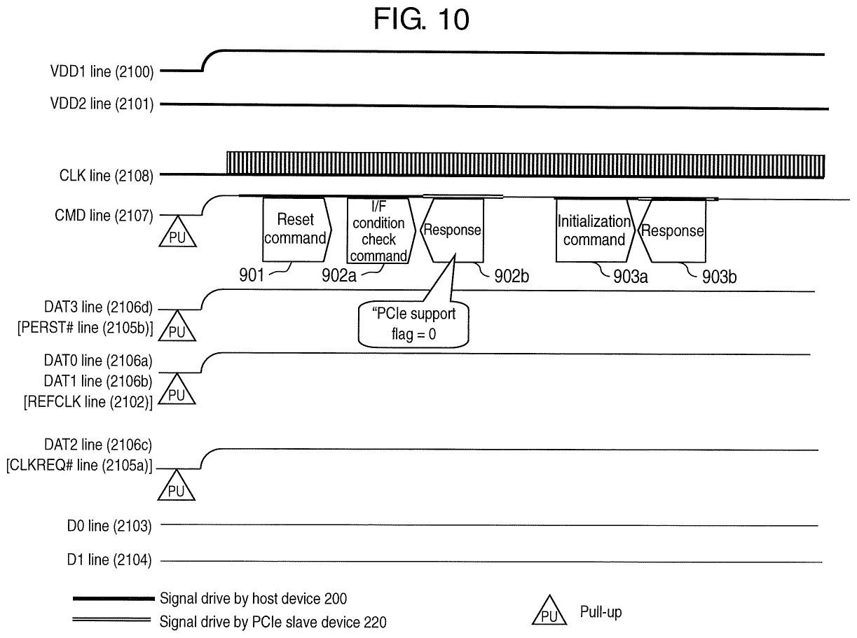

With reference to FIGS. 7 and 10, a description is hereinafter provided of initialization operation that is caused when PCIe slave device 220 is not connected to host device 200.

After power activation, host device 200 supplies a clock and transmits reset command 901 and I/F condition check command 902a as in FIG. 9. When a slave device is not PCIe slave device 220, the slave device transmits to host device 200 response 902b with the value of the PCIe support flag being “0” upon receiving I/F condition check command 902a.

By receiving response 902b with the value of the PCIe support flag being “0”, host device 200 determines that the slave device does not support the PCIe, and subsequently transmits initialization command 903a to continue initialization of the legacy I/F.

Here 1.8 V power is not supplied via VDD2 line 2101, and no signal is supplied via D0 line 2103 intended for differential signals. As such, even if the slave device is slave device 320 equipped with the SIM, neither the power nor the signal is supplied to the second row, so that no contact mismatch (short circuit) is caused.

According to the exemplary embodiment of the present disclosure, when PCIe slave device 220 is not connected to host device 200, the fact that the PCIe I/F is not being supported is detected by means of the PCIe support flag as described above, so that neither the 1.8 V power nor the PCIe I/F signal is supplied via those contacts in the second row. Consequently, no problem is caused to the SIM.

### [2-4. Effects]

According to the present exemplary embodiment, host device 200 first initializes the legacy I/F to a device being connected. If the initialization has failed, host device 200 determines that the connected device is not a slave device. If the legacy I/F is successfully initialized, host device 200 determines next whether or not the slave device in question supports the PCIe. If the slave device supports the PCIe, host device 200 starts initialization of the PCIe I/F. If the slave device does not support the PCIe, host device 200 continues the initialization of the legacy I/F.

Even when connected to any of the devices including legacy slave device 120 (FIG. 3A), PCIe slave device 220 (FIG. 3B), and slave device 320 equipped with the SIM (FIG. 5), host device 200 can select the appropriate interface through negotiation with the slave device in question.

Host device 200 can also determine a kind of I/F that the connected device supports by supplying power and the signal to the connected device's area that corresponds to first area 10 (refer to, for example, FIG. 3A, 3B, or 5) and is common to the slave devices whose connections to host device 200 are presumable. In other words, host device 200 does not supply, until the connected device is determined as being PCIe slave device 220, power and the signal to the area corresponding to second area 20 that is intended to make the PCIe available (refer to, for example, FIG. 3B), that is to say, to the area where the SIM of slave device 320 is disposed.

As such, even when, for example, slave device 320 illustrated in FIG. 5 is fitted to host device 200, the initialization of the PCIe I/F by host device 200 is avoided, whereby a contact mismatch (short circuit) between host device 200 and SIM 302 and resulting damage to host device 200 as well as to SIM 302 can be prevented.

Moreover, even when the device (not illustrated) supporting neither the legacy I/F nor the PCIe I/F is connected to host device 200, host device 200 can determine properly that this device is not available as a slave device. Host device 200 can thus prevent unwanted power and unwanted signals from being supplied to this device. Particularly if this device is the SIM card, host device 200 can initialize the SIM card instead of initializing the I/F to the slave device.

The present exemplary embodiment described above enables both the maintained compatibility of the interfaces and safe use even when any of the slave devices or the device other than the slave devices is fitted to host device 200.

An amplitude of each of the signals that are output from host device 200 via DAT lines 2106, CMD line 2107, and CLK line 2108 does not have to be 3.3 V and may be another voltage such as 1.8 V.

In the present exemplary embodiment, PCIe slave device 220 having the PCIe I/F has been described but is not limiting. Even on, for example, a slave device having an I/F such as a differential I/F (e.g., UHS-II I/F) that as with the PCIe I/F, uses differential signals and uses a contact group common to the legacy I/F (contact group included in first area 10) and a contact group that is used for the differential I/F (contact group included in second area 20), host device 200 can perform the same operation as on PCIe slave device 220.

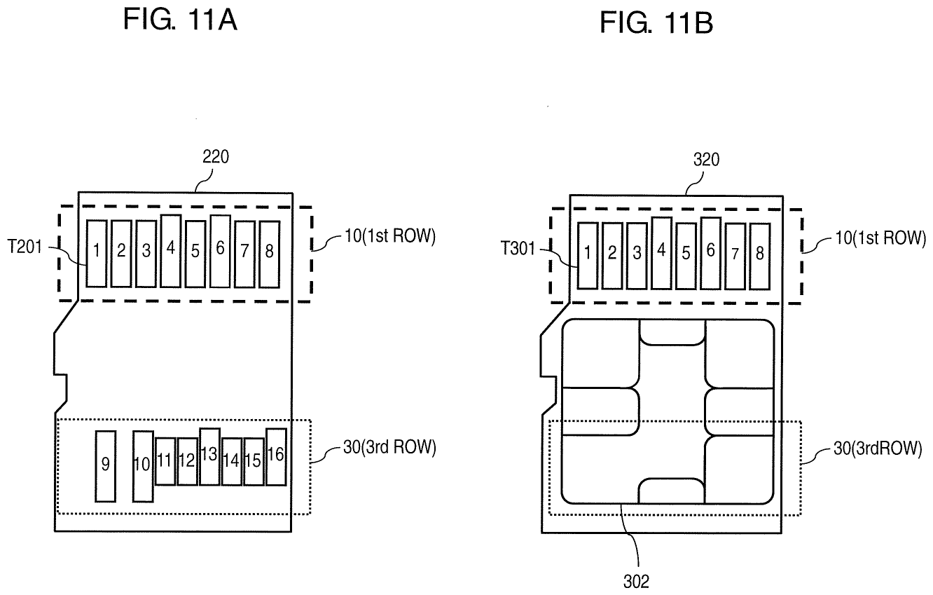

In the present exemplary embodiment, the description has been provided of the PCIe I/F that exists in the FIG. 3B position. What is also conceivable is a case where the contact group for the PCIe I/F is added to a new position that is illustrated in FIG. 11A as a third area. As illustrated in FIG. 11B, this third area is covered by the area for those contacts of the SIM, so that obtained effects are the same as in the present exemplary embodiment.

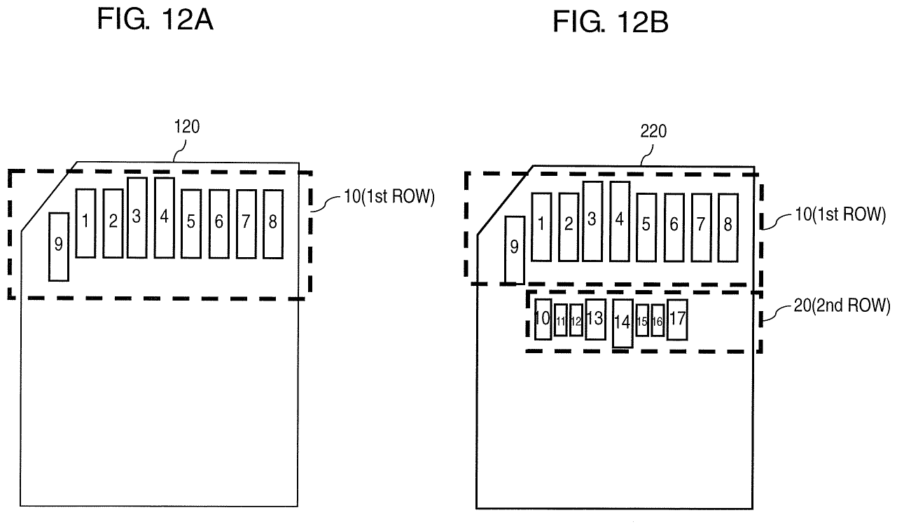

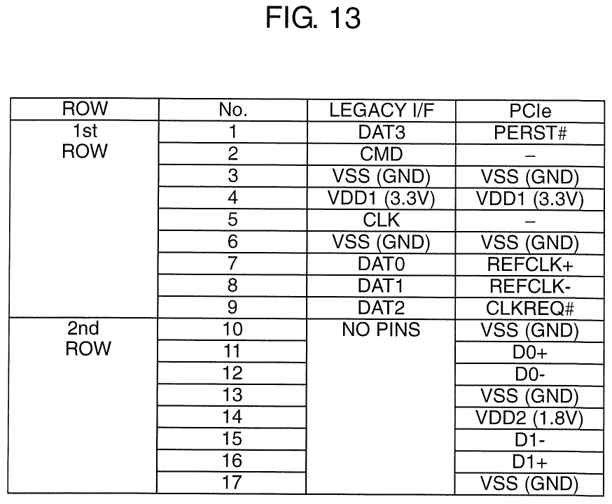

Valid slave devices (SD cards) of the present disclosure include not only those microSD cards respectively having the pin arrangements illustrated in FIGS. 3A, 3B, and 4, but also full-size SD cards respectively having pin arrangements illustrated in FIGS. 12A, 12B, and 13.

The above has been the description of the exemplary embodiment according to the aspect of the present disclosure.

### INDUSTRIAL APPLICABILITY

One aspect of the present disclosure can be applied to a slave device such as an SD card and a compatible host device as well as to a removable system including the host device and the slave device.

### REFERENCE MARKS IN THE DRAWINGS

100: legacy host device
101, 501: power supply unit
102, 121: legacy I/F semiconductor chip
103, 122: regulator
104, 123: SW
105: host-device I/F unit
106, 125, 206, 224: I/F controller
120: legacy slave device
124, 223: slave-device I/F unit
126, 227: back-end module
200, 500: host device
201: first power supply unit
202: second power supply unit
203, 221, 503, 521: PCIe semiconductor chip
204, 222, 504, 522: PCIe regulator
205: host-device I/F unit
220, 520: PCIe slave device

1. A host device that is connected to either a first slave device supporting a first interface or a second slave device supporting a second interface that is different from the first interface, the host device comprising:
a controller that initializes the first interface to a first device connected to the host device, and determines whether or not the first device is the second slave device when the first interface is successfully initialized; and
an interface unit that initializes the second interface when the first device is the second slave device, and continues the initialization of the first interface when the first device is not the second slave device.

2. The host device according to claim 1, wherein the controller determines that the first device is neither the first slave device nor the second slave device when the initialization of the first interface to the first device fails.

3. The host device according to claim 2, wherein the controller performs SIM initialization on the first device when the initialization of the first interface to the first device fails.

4. The host device according to claim 1, wherein the controller determines whether or not the first device is the second slave device based on a signal that is transmitted from the first device, the signal indicating whether or not the second interface is supported.

5. The host device according to claim 4, wherein the signal indicating whether or not the second interface is supported is included in a response to a command that is intended to check an interface condition for the initialization of the first interface.

6. The host device according to claim 4, wherein the signal indicating whether or not the second interface is supported is included in a response to a command directing that the first interface be initialized.

7. The host device according to claim 4, wherein the signal indicating whether or not the second interface is supported is included in output data that is transmitted from the first device in response to a command directing that a register be read during the initialization of the first interface.

8. The host device according to claim 1, wherein:
the first slave device includes a first contact group that is arranged in a first area to be used for both the first interface and the second interface;
the second slave device includes the first contact group arranged in the first area, and a second contact group that is arranged in a second area different from the first area, the second contact group being used for only the second interface; and
the interface unit initializes the second interface via both the first contact group and the second contact group when the first device is the second slave device, and continues the initialization of the first interface via the first contact group when the first device is not the second slave device.

9. The host device according to claim 1, wherein the second interface is an interface using a differential signal.

10. A removable system comprising:
a host device that is connected to either a first slave device supporting a first interface or a second slave device supporting a second interface that is different from the first interface; and
one of the first slave device and the second slave device,
wherein
the host device initializes the first interface to a first device connected to the host device, and determines whether or not the first device is the second slave device when the first interface is successfully initialized, and
the host device initializes the second interface when the first device is the second slave device, and continues the initialization of the first interface when the first device is not the second slave device.
